(19) United States
(12) Patent Application Publication
(10) Pub. No.: US 2019/0030549 A1
(43) Pub. Date: Jan. 31, 2019

(54) IMPROVED AEROSOL COATING DEVICE AND METHOD

(71) Applicant: BENEQ OY, Espoo (FI)

(72) Inventors: Kai ASIKKALA, Espoo (FI); Simo TAMMELA, Espoo (FI); Tuomo MÄÄTTÄ, Espoo (FI)

(21) Appl. No.: 16/072,170

(22) PCT Filed: Feb. 23, 2017
(86) PCT No.: PCT/FI2017/050119

§ 371 Date: Jul. 23, 2018

(30) Foreign Application Priority Data
Feb. 26, 2016 (FI) 20165151

(51) Int. Cl. B05B 1/26; B05B 7/08; B05D 1/06; B05D 1/22

(52) U.S. Cl. CPC B05B 1/26; B05B 7/0838; B05D 1/36; B05D 1/22; B05D 1/06

(57) ABSTRACT

A coating method that improves uniformity of coatings that settle on more complex objects, like porous substrates, or substrates with hollows or curvy forms, and a device for implementing the method. The coating device includes a deposition chamber, and a loading structure configured to load an object into a position in the deposition chamber and unload the object from the deposition chamber. The coating device includes an atomization element in a bottom part of the deposition chamber, the atomization element creating into the deposition chamber an aerosol volume that includes a floating aerosol region in the top part of the deposition chamber. The loading structure is configured to load the object into a position in the floating aerosol region in the deposition chamber.

### BACKGROUND

The invention relates to a coating device and a coating method as defined in the preambles of the independent claims.

### DESCRIPTION OF THE RELATED ART

In many prior art coating systems, an aerosol jet is directed toward a substrate such that droplets of the aerosol jet impact the surface of the substrate to be coated. Typically the atomizing head is arranged to face the surface to be coated so that the aerosol jet points to an impact region on a surface of the substrate. The aerosol then travels on the surface of the substrate to another point where parts of the aerosol that have not participated in the coating process is removed.

In other prior art solutions, two atomized aerosol jets are oriented opposite each other so that aerosol is produced in the collision point of the aerosol jets. The produced aerosol is moved toward the substrate to be coated by means of a gas stream blown to the collision point.

It has, however, proven difficult to control sufficiently uniform coatings with these prior art methods in which deposition is mainly based on impaction. The thickness of the coating on the substrate surface tends to vary too much for many applications.

To overcome this problem, in some further prior art solutions, saturated aerosol mix is created in an atmospheric state in a deposition chamber, and the saturated aerosol droplets are allowed to settle by gravitation toward the substrate. The volume of the deposition chamber is kept in a saturated state such that the coating spreads on a large planar surface evenly, and results in a uniformly distributed liquid thin film on the substrate surface. After a deposition time, the coated substrate is moved into a separate drying chamber where the liquid thin film dries in a manageable way. The method has been successfully applied for various purposes, but it has been discovered that a system in which aerosol droplets settle by gravitation is best suited for coating planar substrates that extend in a horizontal direction, i.e. normal to the gravitation. There is a clear need to improve uniformity of coatings that settle on more complex objects, like porous substrates, or substrates with hollows or curvy forms.

Coating of such objects is problematic, because each of the coated surfaces should be evenly exposed to the impacting spray. This means that the coating device should include a mechanism that changes the orientation of the coated object in relation of the impacting spray according to its shape. Implementation of such orientation changing mechanisms, especially for a larger scale objects, is complicated. Furthermore, even with such moving mechanisms, production of thin, even films is challenging. In order to ensure that the all surface parts do get exposed, despite the potentially intervening forms between the spray and the current part to be sprayed, many parts may be exposed to the spray several times or longer periods or both. Therefore, the thickness of the film on the coated surfaces tends to vary considerably.

Atomic layer deposition (ALD) method is based on use of a gas phase chemical process, in which precursors react with the surface of a material one at a time in a sequential, self-limiting manner. Through the repeated reactions, a coating film is created. The resulting film is very uniform even on complex surfaces, but the process is slow and does not easily scale to coating of large objects.

### SUMMARY

An object of the present invention is to provide a system that enables creation of an even coating film also on non-planar, large-scale objects with a simple device configuration.

The coating device of the invention is characterized by the definitions of the independent claim 1. Some embodiments of the coating device are defined in the dependent claims 2 to 16.

The coating method of the invention is correspondingly characterized by the definitions of independent claim 17. Some embodiments of the coating method are defined in the dependent claims 18 to 23.

In the disclosed embodiments, the coating device includes a deposition chamber enclosing a bottom part and a top part, wherein the bottom part is below the top part, a loading element configured to load an object into the deposition chamber and unload the object from the deposition chamber, and a source of aerosol within the deposition chamber. The aerosol source is configured to feed into the bottom part of the deposition chamber a flow of aerosol that includes solid or liquid particles in gas. The loading element is configured to load the object into the top part of the deposition chamber. The aerosol source is adjusted to generate a volumetric flow that rises in the deposition chamber against the direction of gravitational settling of the particles. The volumetric flow is adjusted to minimize the terminal settling velocity of the particles in the top part to create a floating aerosol.

In the disclosed embodiments, the coating method comprises coating an object in a deposition chamber that encloses a bottom part and a top part, wherein the bottom part is below the top part. The method includes also feeding into the bottom part of the deposition chamber a flow of aerosol that includes solid or liquid particles in gas to generate into the bottom part of the deposition chamber a volumetric flow that rises in the deposition chamber against the direction of gravitational settling of the particles. The volumetric flow is adjusted to minimize the terminal settling velocity of the particles in the top part such that floating aerosol is created. The object is loaded into the top part of the deposition chamber, and unloaded from the deposition chamber after a deposition period.

Further advantages are discussed in more detail with embodiments described in the following.

### BRIEF DESCRIPTION OF THE DRAWINGS

In the following the invention will described in more detail by referring to the attached drawings, in which:

FIG. 1 illustrates an exemplary embodiment of a coating device;

FIG. 2 shows a further embodiment of a coating device configured for use of solid particles;

FIG. 3 illustrates an exemplary embodiment of a coating device that includes three successive deposition chambers.

### DETAILED DESCRIPTION

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a device architecture with which various embodiments of the invention may be implemented. Only elements relevant for illustrating the embodiments are described in detail. Various components of coating devices, which are generally known to a person skilled in the art, may not be specifically described herein.

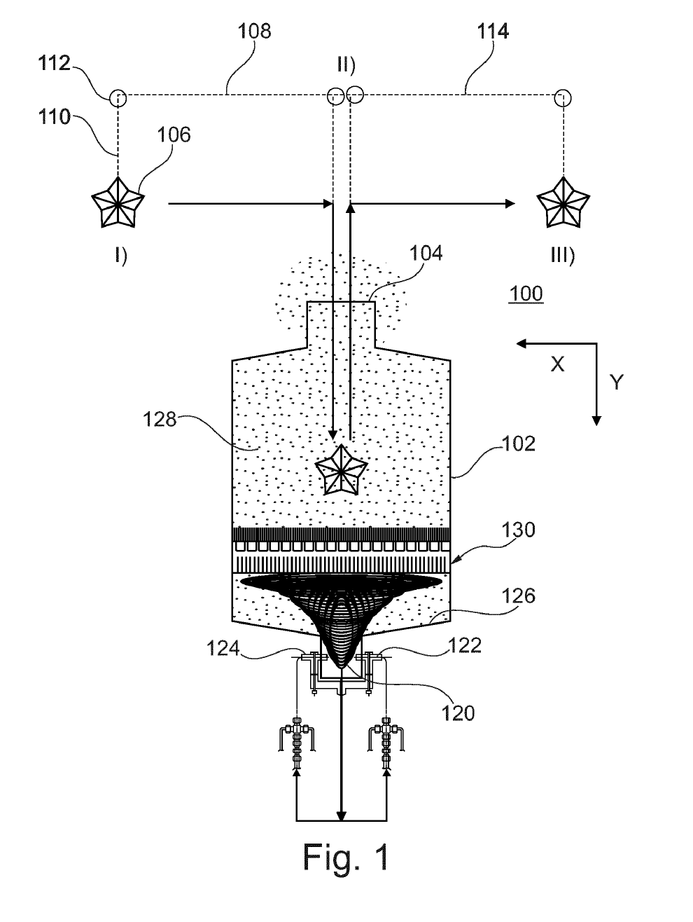

FIG. 1 illustrates an exemplary embodiment of a coating device 100 applicable for uniform coating of planar and non-planar objects. The coating device 100 includes a deposition chamber 102, a solid structure that forms an enclosed space with a non-zero volume. The term enclosed means here that the solid structure of the deposition chamber enables formation of a volume cell that has no interference or only gradual interference from the outside. The conditions within the deposition chamber are therefore mainly determined by the initial state of the volume in the deposition chamber, physical and chemical events that take place in the deposition chamber, and controlled input operations to and output operations from the deposition chamber. The deposition chamber may include an opening 104 that enables loading and unloading of objects for deposition within the chamber. The opening may be permanently open, or include a closure mechanism that enables opening and closing of the opening 104, in each case, however, arranged to enable minimal unintentional exchange of the aerosol volume in the deposition chamber with the ambient atmosphere.

The coating device includes also a loading element 108 configured to load an object 106 into the deposition chamber 102, and unload the object 106 from the deposition chamber 102. In FIG. 1, the loading structure 108 has been illustrated with a wire transfer system that includes a vertical wire connector 110 that can be removably attached to the object and a rolling mechanism 112 allows the wire of the vertical wire connector 110 to be lengthened or shortened, thereby enabling lowering and lifting of the object in a vertical direction. The rolling mechanism 112 may also include a slide, for example a rotary slide, which enables transfer of the vertical wire connector along a horizontal wire connector 114. The wire transfer system shown in FIG. 1 is, however, exemplary only. Any loading mechanism applicable for transferring objects to be coated into the deposition chamber may be used within the scope. For example, the deposition chamber 102 may include a side wall with one or more openings (e.g. a hatch, or a door or the like) that allow loading of the object into the deposition chamber in the horizontal direction.

The coating device 100 includes also a source of aerosol configured to feed into a bottom part of the deposition chamber a flow of aerosol that includes solid or liquid particles in gas. In the exemplary embodiment of FIG. 1, the aerosol source is illustrated by means of an atomization element 120 with inlets inside the deposition chamber 102. The deposition chamber can be considered to enclose a bottom part 126 and a top part 128, wherein the bottom part is below the top part. If denoted that the vertical direction Y corresponds to the direction of the gravitation, the bottom part 128 of the deposition chamber is a part of the deposition chamber lowest (closest to the ground) in the vertical direction, when the deposition chamber is in use. The top part is then opposite of the bottom part in the vertical direction, when the deposition chamber is in use. The feed of the atomization element 120 is arranged to a position in the bottom part of the deposition chamber. The atomizer is adapted to generate an aerosol with very small particles, which disperse into the volume cell. Larger particles with a small terminal settling velocity tend to settle back towards the bottom part of the deposition chamber and can be collected and re-fed as liquid to the atomization element 120. However, smaller particles with a very long terminal settling velocity act more or less like gas molecules of the aerosol gas, disperse into the volume cell and collide with other particles and the gas molecules.

The term aerosol refers here to a colloidal system of solid or liquid particles in a suspending gas. The liquid or solid particles have a diameter mostly smaller than 1 μm. In the deposition chamber, particles of the aerosol undergo gravitational settling and tend to reach a terminal settling velocity. Accordingly, when the aerosol source is in the top part of the deposition chamber, or in the absence of the aerosol source, particles within the deposition chamber tend to settle linearly downwards in the direction of the gravitation. When the aerosol source is in the bottom part of the deposition chamber, it creates there a volumetric flow that disperses radially to the enclosed chamber volume and rises in the deposition chamber against the direction of the gravitational settling of the particles. For example, let us assume that the diameter of the cylindrical chamber of FIG. 1 is 38 cm, i.e the cross-sectional area of the chamber is A=11.34 dm². If the rate of aerosol input is V=30 dm³/min, the volumetric flow rises approximately v=V/A=4.4 mm/s.

It has now been detected that by means of a predefined adjustment of the aerosol input in the bottom part of the deposition chamber, the terminal settling velocity of particles in the top part of the chamber can be controllably slowed down such that instead of linearly undergoing gravitational settling, particles practically float in the suspending gas, or settle with extremely slow velocity downwards. In these conditions, particles are mainly subject to complex interparticle interactions of particle agglomeration, due to which the direction of their motion is mainly random. The particles in the top part thus move practically evenly in all directions. Accordingly, when an object is enclosed into the top part of the deposition chamber, particles approach it from all directions, not only linearly from above. The random motion of particles floating in the aerosol also enables penetration of the particles to cavities and pores of the object, notwithstanding the orientation of them in respect of the gravitation. An even coating is thus deposited on all surfaces of the object.

Accordingly, the aerosol source is adjusted to generate a volumetric flow that rises in the deposition chamber against the direction of gravitational settling of the particles. Creation of the volumetric flow is adjusted to minimize the terminal settling velocity of the particles in the top part to create a floating aerosol. In the floating aerosol, random mode of motion of the particles prevails over gravitational settling mode of the particles. It has been detected that this unexpected non-impact deposition mode is achieved when the terminal settling velocity of the particles is controlled to a range below 1 mm/s.

In this range, particles of the floating aerosol in the top part of the deposition chamber can be considered to behave like molecules of the aerosol gas. This means that due to collisions between the particles and gas molecules in the aerosol, the motion of the particles is random, and the direction from which the particles approach an object to be coated is similarly random. Because of this, particles distribute quite evenly over all surfaces of the object, notwithstanding whether a surface is horizontal or not. As the aerosol is denser than air it also supersedes air in open cavities or dents in the surface of the object to be coated, which further intensifies transportation of the particles towards non-linear surfaces of the object, or even into surfaces of a porous object. Advantageously, in use, the top part of the deposition chamber is filled with an amount of floating aerosol, and a constant concentration of the particles is maintained such that a stationary non-stop coating cell that includes a high concentration of particles with high mechanical mobility in all directions is formed. In case of liquid particles, the conditions in the deposition chamber are advantageously arranged to maintain a saturated state of vapor-liquid equilibrium where the rate of evaporation equals to the rate of condensation on a molecular level such that the net overall conversion from vapor to liquid and from liquid to vapor is practically zero. Existence of such stationary non-stop coating cell of floating aerosol may typically be determined visually, as the floating aerosol forms a fog-like cloud of substance that, after having filled the top part of the deposition chamber, due to the minimized terminal settling velocity, remains practically unchanged in it.

In FIG. 1, the aerosol source is illustrated by means of an atomizing apparatus that provides an aerosol including liquid droplets in gas. Similar arrangement is disclosed, for example, in an earlier patent application publication WO2015033027A1 of the Applicant. The apparatus includes two atomizers, wherein a first atomizer 122 is used for producing a first atomized aerosol jet and a second atomizer 124 is used for producing a second atomized aerosol jet. The atomized aerosol jets may be produced from one or more liquid precursors and discharged from the atomizer through a discharge opening in the atomizer. Each atomizer may comprise an atomizing head in which liquid is atomized into an atomized aerosol jet. Said atomizers may further comprise a focusing part arranged to restrain the atomized aerosol jet for providing a punctual aerosol jet, said focusing part extending directly from the atomizing head. The first atomizer 122 and the second atomizer 124 may be arranged to form an atomizer pair in which the focusing parts of the paired atomizers are directed towards each other. As a result, the first aerosol jet and the second aerosol jet collide to each other and form micro and nano scale droplets with a relatively narrow standard deviation of size. The collision of the aerosol jets produce a pressure point from which a planar aerosol zone will spread out creating an aerosol flow. The density of the droplets equalizes in the stationary deposition chamber and creates a rising volumetric flow, described earlier.

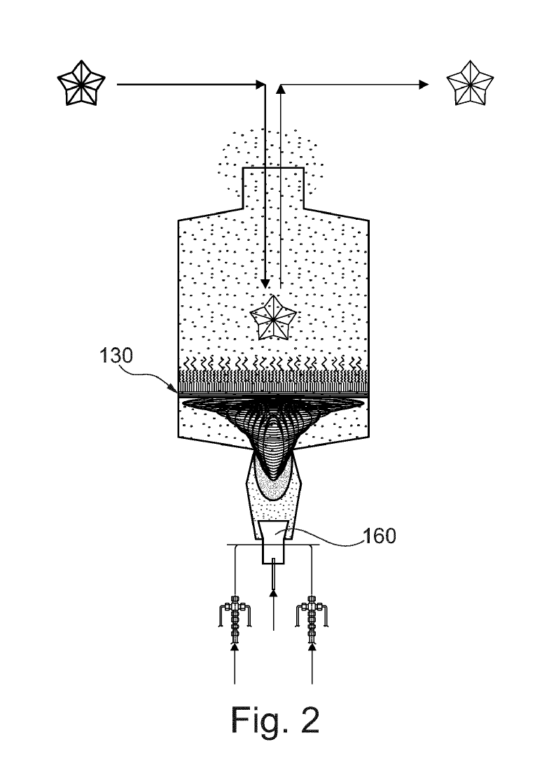

FIG. 2 shows a further illustration of an aerosol source, configured for use of solid particles. In the exemplary embodiment, the coating device includes a nozzle 160 for gaseous or atomized liquid raw materials. The evaporation condensation into solid particles may be achieved in a controlled manner with heated gas or by combustion of sprayed substances. It is also possible to generate the solid particles, for example by the liquid flame spraying method, in a separate chamber and feed them with a controlled volume of gas through the nozzle 160 into the bottom part of the deposition chamber.

It is noted that the shown aerosol source elements are exemplary only. As well known by a person skilled in the art, there are many alternative ways of creating aerosols with solid or liquid micro-scale particles with a desired number or mass concentration. Any such method may be applied within the scope.

Returning to FIG. 1, the coating device may also include an equalizing element 130 that is arranged to a position between the atomizing element 120 and the top part of the deposition chamber 102 in which the object to be coated is to remain during the deposition. The equalizing element 130 may be used to expedite the horizontal spreading of the particles and thereby enhancing the creation of the desired stationary cell with uniform particle distribution to the top part 128 of the deposition chamber. The equalizing element 130 may include a horizontal wall for dispersing the created aerosol in the horizontal direction and flow-through channels for guiding the created and dispersed aerosol to regions above the equalizing element in the deposition chamber. In the exemplary structure of FIG. 1, the equalizing element 130 is illustrated with a perforated plate that extends horizontally throughout the volume cell, and through which the aerosol created in the atomizing element 120 is arranged to flow into the deposition chamber. Other structures capable of expediting the spreading of the particles may be used within the scope.

During use, an object to the coated 108 may be taken through states I), II), and III), shown in FIG. 1. In state I), the object to be coated is outside the deposition chamber. In state II), the object to be coated is inserted to the volume of uniform floating aerosol in the top part of the deposition chamber 102, and kept there for a defined time of deposition. During this time, the particles within the deposition chamber are transported from random directions towards surfaces of the object, and collect on those surfaces practically without gravitational sedimentation or impaction. A variety of deposition mechanisms may be involved in the final adherence to the surfaces, alone or in combination. Examples of such deposition mechanisms include thermophoresis, turbophoresis, diffusiophoresis and electrophoresis.

In the exemplary embodiment of FIG. 1, the opening 104 of the deposition chamber 102 is shown to be open. In case the temperature and pressure conditions in the deposition chamber and outside the deposition chamber are similar, the interaction between the volume of floating aerosol within the deposition chamber and the ambient air is typically acceptable even with a permanently open opening. However, in order to reduce any possible unintentional interactions from the outside, for example spurious air waves from the ambient air, and additional protective component may be mounted on the opening. For example, hatch or a detachable reducer may be applied for the purpose.

The purposive selection of the floating aerosol particle constitution enables a very simple and easy method to create a uniform thin coating on objects of any form and size. Conventionally thin coating of non-planar objects has required use of state of the art systems, like atomic layer deposition. Such methods typically require vacuum reaction chambers and careful control of the highly reactive precursor combinations. With the floating aerosol, coating can be performed in normal atmospheric conditions without complicated and expensive control arrangements. It is also possible to adjust the coating substances and stabilize the temperatures of the object within the deposition chamber in relation to each other such that the thickness of the coating layer is practically proportional to the selected deposition time only. This considerably simplifies also the use of the coating device.

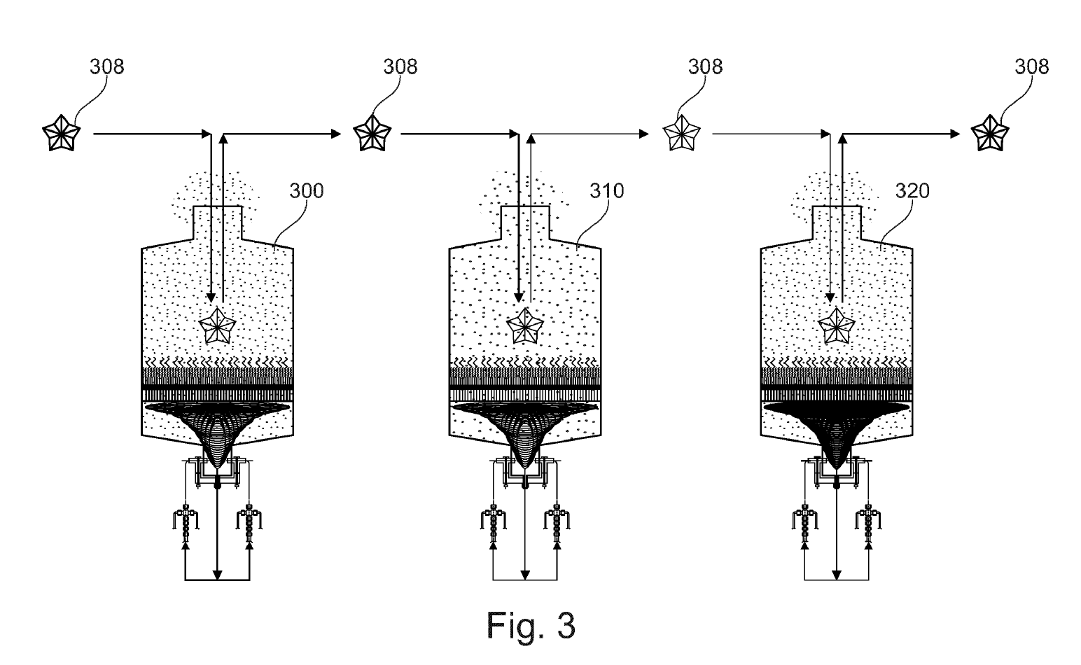

In an aspect, the coating device may include two or more deposition chambers. FIG. 3 illustrates an exemplary embodiment of a coating device that includes three successive deposition chambers 300, 310, 320. The loading structure (not shown) may thus be configured to transport the object 308 successively into the two or more deposition chambers. FIG. 3 shows the same object 308 in various stages of its progress of being loaded into successive deposition chambers. A first floating aerosol of a first substance can be created into a top part of a first deposition chamber 300, a second floating aerosol of a second substance can be created into a top part of a second deposition chamber 310, and a third floating aerosol of a third substance can be created into a top part of a third deposition chamber 320.

Advantageously, the first substance, the second substance and the third substance are of different composition to achieve a desired effect to the coating process or its results. For example, a defined coating type or a decrease to the process duration may be desired.

In an aspect, the first floating aerosol and the substance of the second floating aerosol may be selected to be chemically reactive. The reactive property may be permanent, or be valid at least within a defined period of time after the object is unloaded from the first deposition chamber. For example, in case of liquid droplets, the thin coating deposited in the first deposition chamber may remain reactive to the substance in the second reaction chamber only when it remains in the saturated floating aerosol of the first deposition chamber, and become non-reactive by drying after the object is unloaded from the first deposition chamber. In such a case, the loading structure may be configured to load the object from the first deposition chamber to the second deposition chamber before the defined period of time such that a reaction between the mutually reactive substances is initiated.

Alternatively, the deposition process of the substance of the first floating aerosol may include, for example, on a chemical reaction. The substance of the second floating aerosol may be arranged to be a catalyst in said chemical reaction. Again, the catalyst property may be permanent, or last at least a defined period of time after loading of the object from the first deposition chamber. The loading structure may then be configured to load the object from the first deposition chamber to the second deposition chamber before the defined period of time such that the chemical reaction and thereby deposition of the first substance is expedited. It is understood that a catalyst may be applied to expedite other parts of the deposition process, for example, coagulation of the particles, development of color shades etc.

As a further alternative, the successive two or more deposition chambers 300, 310, 320 may include substances that each deposit separately onto the object. As a result of successive exposure of the object to the floating aerosol in the deposition chambers, a layered polyfilm of even and thin coating films is created on the object.

In the exemplary embodiment of FIG. 3, the first floating aerosol of the first deposition chamber 300 may include droplets of a liquid coloring mixture, the second floating aerosol of the second deposition chamber 310 may include droplets of a catalyst mixture applicable to develop the color to a desired shade, and the third floating aerosol of the third deposition chamber 320 may include droplets of a resin mix applicable to create a transparent protective layer on the color layer.

As another example, the first floating aerosol of the first deposition chamber 300 may include droplets of a first liquid substance, the second floating aerosol of the second deposition chamber 310 may include droplets of a second liquid substance that is reactive with the first liquid substance. In the first deposition chamber, the first liquid substance spreads evenly on the surfaces of the object, but does not solidify to create a durable coating. In the second deposition chamber, the second liquid substance also spreads evenly on the surfaces of the object, and the substances react creating a solid coating on all surfaces of the object. The third floating aerosol of the third deposition chamber 320 may again be used to create a transparent protective layer on the layer resulting from the reactions of the first and the second liquid substance.

As a further example, the first floating aerosol of the first deposition chamber 300 may include droplets of a first liquid substance, and the second floating aerosol of the second deposition chamber 310 may include solid pigment particles. In the first deposition chamber, the first liquid substance spreads evenly on the surfaces of the object, and provides an adhesive layer on them. In the second deposition chamber, the pigment particles also spread evenly on the surfaces of the object, and adhere to the first layer, creating an evenly colored coating on all surfaces of the object. The third floating aerosol of the third deposition chamber 320 may again be used to create a transparent protective layer on the layer resulting from the reactions of the first and the second liquid substance. Alternatively, the third floating aerosol of the third deposition chamber 320 may include solid pigment particles of another color such that the final color on the surfaces of the object results from pigment particles of the second deposition chamber 310 and the third deposition chamber 320.

The deposition chamber encloses a peripheral passage providing the cross-sectional area of the volumetric flow. As discussed earlier, the aerosol fed from the aerosol source can be considered to first disperse horizontally to the available volume inside the deposition chamber, and the rate of rising of the volumetric flow is thus dependent of the cross-sectional area of the chamber volume. By adjusting the cross-sectional area of the volumetric flow, it is possible to control the position in the deposition chamber where the condition of random particle movement takes place. For example, when the cross-sectional area of the volumetric flow increases as a function of distance from the aerosol source, the rate of rising of the aerosol flow slows down correspondingly. If the rate of flow from the aerosol source is difficult to control, the point where the object can be loaded for exposure of randomly moving particles can be controlled by design of the deposition chamber. The desired increase of the cross-sectional area may be achieved by designing the peripheral passage to have a form of a truncated cone.

It is easily understood that the basic idea of the invention can be implemented in various ways to create thin, even layers by means of one or more component substances on planar or non-planar, and porous or impermeable objects. Since the arrangement is very simple, also larger scale objects, for example in the order of vehicle components, or air conditioning channels may be coated with the coating device described herein. Furthermore, the deposition chambers do not need to be applied in one-directional order of succession. An algorithm controlling the order of loading and/or the duration of each loaded state may be applied to achieve a desired composition of the resulting coating film.

It is apparent to a person skilled in the art that as technology advances, the basic idea of the invention can be implemented in various ways. The invention and its embodiments are therefore not restricted to the above examples, but they may vary within the scope of the claims.

1. A coating device, including:
a deposition chamber enclosing a bottom part and a top part, wherein the bottom part is below the top part;
a loading element configured to load an object into the deposition chamber and unload the object from the deposition chamber;
a source of aerosol within the deposition chamber, characterized in that
the aerosol source is configured to feed into the bottom part of the deposition chamber a flow of aerosol that includes solid or liquid particles in gas;
the loading element is configured to load the object into the top part of the deposition chamber;
the aerosol source is adjusted to generate a volumetric flow that rises in the deposition chamber against the direction of gravitational settling of the particles; and
the rising of the volumetric flow is adjusted to minimize the terminal settling velocity of the particles in the top part to create a floating aerosol.

2. The coating device of claim 1, characterized in that in the floating aerosol, random mode of motion of the particles prevails over gravitational settling mode of the particles.

3. The coating device of claim 1, characterized in that the volumetric flow is adjusted to decrease the terminal settling velocity of the particles in the top part below 1 mm/s.

4. The coating device of claim 1, characterized in that the deposition chamber encloses a peripheral passage providing the cross-sectional area of the volumetric flow.

5. The coating device of claim 4, characterized in that in at least part of the peripheral passage, the cross-sectional area of the volumetric flow increases as a function of distance from the aerosol source.

6. The coating device of claim 4, characterized in that the peripheral passage has a form of a truncated cone.

7. The coating device of claim 1, characterized in that particles in the aerosol are liquid droplets.

8. The coating device of claim 7, characterized in that the aerosol source includes:
a first atomizer for generating a first aerosol jet;
a second atomizer for generating a second aerosol jet; and
the first aerosol jet of the first atomizer and the second aerosol jet of the second atomizer are arranged to collide to form liquid droplets of the aerosol.

9. The coating device of claim 1, characterized in that
the coating device includes an equalizing element;
the equalizing element includes a horizontal wall for dispersing the created aerosol in the horizontal direction and flow-through channels for guiding the created and dispersed aerosol to regions above the equalizing element in the deposition chamber.

10. The coating device of claim 1, characterized in that the deposition chamber is arranged to maintain a saturated state of vapor-liquid equilibrium in the top part of the deposition chamber.

11. The coating device of claim 1, characterized in that particles in the floating aerosol are solid particles.

12. The coating device of claim 1, characterized in that the coating device comprises two or more deposition chambers, and the loading element is configured to insert the object successively into the two or more deposition chambers.

13. The coating device of claim 12, characterized in that a first source of aerosol is configured to feed a first aerosol into the bottom part of the first deposition chamber, and a second source of aerosol is configured to feed a second aerosol into the bottom part of the second deposition chamber.

14. The coating device of claim 13, characterized in that the substance of the first aerosol and the substance of the second aerosol are chemically reactive at least within a defined period of time after unloading of the object from the first deposition chamber.

15. The coating device of claim 13, characterized in that the substance of the second aerosol is a catalyst in a deposition process of the substance of the first aerosol at least within a defined period of time after loading of the object from the first deposition chamber.

16. The coating device of claim 12 characterized in that the loading element is configured to load the object from the first deposition chamber to the second deposition chamber before the defined period of time.

17. A coating method, comprising:
coating an object in a deposition chamber that encloses a bottom part and a top part, wherein the bottom part is below the top part; characterized by:
feeding into the bottom part of the deposition chamber a flow of aerosol that includes solid or liquid particles in gas to generate into the bottom part of the deposition chamber a volumetric flow that rises in the deposition chamber against the direction of gravitational settling of the particles;
adjusting the rate of the volumetric flow to minimize the terminal settling velocity of the particles in the top part to create a floating aerosol;
loading the object into the top part of the deposition chamber; and
unloading the object from the deposition chamber after a deposition period.

18. The method of claim 17, characterized in that in the floating aerosol, random mode of motion of the particles prevails over gravitational settling mode of the particles.

19. The method of claim 17, characterized in that the volumetric flow is adjusted to decrease the terminal settling velocity of the particles in the top part below 1 mm/s.

20. The coating method of claim 17, characterized by loading the object successively into the two or more deposition chambers.

21. The coating method of claim 20, characterized by loading the object into a first aerosol of one substance in a first deposition chamber, and thereafter to a second aerosol of another substance in a second deposition chamber.

22. The coating method of claim 21, characterized in that the substance of the first aerosol and the substance of the second aerosol are chemically reactive at least within a defined period of time after unloading of the object from the first deposition chamber, and the method includes loading the object from the first deposition chamber to the second deposition chamber before the defined period of time.

23. The coating method of claim 21, characterized in that the substance of the second aerosol is a catalyst in a deposition process of the substance of the first aerosol at least within a defined period of time after loading of the object from the first deposition chamber, and the method includes loading the object from the first deposition chamber to the second deposition chamber before the defined period of time.
